(19) United States
(12) Patent Application Publication
(10) Pub. No.: US 2024/0163960 A1
(43) Pub. Date: May 16, 2024

(54) METHODS, DEVICES, AND MEDIUM FOR COMMUNICATION

(71) Applicant: NEC Corporation, Tokyo (JP)

(72) Inventors: Da WANG, Beijing (CN); Lin LIANG, Beijing (CN); Gang WANG, Beijing (CN)

(73) Assignee: NEC Corporation, Tokyo (JP)

(21) Appl. No.: 18/576,537

(22) PCT Filed: Jul. 5, 2021
(86) PCT No.: PCT/CN2021/104605

§ 371 Date: Jan. 4, 2024

(51) Int. Cl. H04W 76/27

(52) U.S. Cl. CPC H04W 76/27

(57) ABSTRACT

Embodiments of the present disclosure relate to a method, device and computer readable storage medium of communication. The method performed by the terminal device comprises initiating an RRC connection release procedure during the terminal device performing a SDT with a network device. The method further comprises disabling indicating an arriving of non-small data transmission to the network device during the RRC connection release procedure. In this way, the RRC connection release procedure may be completed without any disturbing, and the state between the terminal device and the network device may be consistent.

### FIELD

Embodiments of the present disclosure generally relate to the field of telecommunication, and in particular, to methods, devices, and medium for communication.

### BACKGROUND

Power consumption of a terminal device is a focus in current wireless communication system. In order to reduce power consumption of the terminal device, it is proposed that the terminal device may be configured in some power saving modes/states (such as, inactive state). As for a terminal device in an inactive state, normal data transmissions are proposed to be suspended. Generally speaking, if the terminal device in the inactive state needs to perform normal transmission with a network device, the terminal device has to resume a connection with the network device (i.e., wake up and transform into a connected state).

In order to further reduce power consumption, a solution for enabling small data transmission (SDT) for the terminal device in the inactive state is proposed by a work item of the third Generation Partnership Project (3GPP). By using SDT, the terminal device in the inactive state may maintain the inactive mode while enabling an uplink (UL) transmission and downlink (DL) transmission following an original UL transmission.

### SUMMARY

In general, example embodiments of the present disclosure provide solutions of communication for a device in an inactive state. Embodiments that do not fall under the scope of the claims, if any, are to be interpreted as examples useful for understanding various embodiments of the disclosure.

In a first aspect, there is provided a method of communication. The method comprises: initiating, at a terminal device, a radio resource control connection release procedure during the terminal device performing a small data transmission with a network device; and disabling indicating an arriving of data from the radio bearers not supporting transmission in inactive state to the network device during the radio resource control connection release procedure.

In a second aspect, there is provided a method of communication. The method comprises: initiating, at a terminal device, a radio resource control connection release procedure during the terminal device performing a small data transmission with a network device; terminating the radio resource control connection release procedure; and indicating an arriving of data from the radio bearers not supporting transmission in inactive state to the network device.

In a third aspect, there is provided a method of communication. The method comprises: receiving, at a terminal device and from a network device, a message comprising a plurality of security elements for deriving a plurality of respective security keys for communication between the terminal device and the network device when the terminal is in a non-connected state; and performing, at least in part based on the message, radio resource control connection resume procedures with the network device when the terminal device is in the non-connected state.

In a fourth aspect, there is provided a method of communication. The method comprises: transmitting, at a network device and to a terminal device, a message comprising a plurality of security elements for deriving a plurality of respective security keys for communication between the terminal device and the network device when the terminal device is in a non-connected state; and performing, at least in part based on the message, radio resource control connection resume procedures with the terminal device when the terminal device is in the non-connected state.

In a fifth aspect, there is provided a method of communication. The method comprises: receiving, at a terminal device and from a network device, information about the maximum number of generating security key based on a security element, the security key used for communication between the terminal device and the network device when the terminal deice is in a non-connected state; and performing, at least in part based on the maximum number, radio resource control connection resume procedures with the network device when the terminal device is in the non-connected state.

In a sixth aspect, there is provided a method of communication. The method comprises transmitting, at a network device and to a terminal device information about the maximum number of generating security key based on a security element the security key used for communication between the terminal device and the network device when the terminal device is in a non-connected state; and performing, at least in part based on the maximum number, radio resource control connection resume procedures with the terminal device.

In a seventh aspect, there is provided a method of communication. The method comprises performing, at a terminal device, a non-connected state transmission with a first cell of a network device by encrypting data with a first sequence number; discarding stored data for radio bearers configured for non-connected state transmission after detecting a pre-configured event for triggering abortion of the non-connected state transmission; and performing, a radio resource control connection resume procedure comprising: performing, the radio resource control connection resume procedure with the first cell by encrypting data with the first sequence number without initialization; or performing, the radio resource control connection resume procedure with a second cell of the network device by encrypting data with the initialized first sequence number.

In an eighth aspect, there is provided a method of communication. The method comprises: detecting, at a terminal device, a pre-configured event during performing of a non-connected state transmission by the terminal device with a network device; and transitioning into an idle state.

In a ninth aspect, there is provided a method of communication. The method comprises performing, at a terminal device, a small data transmission with a first cell configured with a first frequency; and decreasing a possibility of switching to a second cell configured with a second frequency different from the first frequency when performing the small data transmission with the first cell.

In a tenth aspect, there is provided a method of communication. The method comprises: receiving, at a terminal device and from a network device a packet data convergence protocol configuration for radio bearers of the terminal device; and initiating a radio resource control connection resume procedure for small data transmission, comprising: applying a default packet data convergence protocol configuration for the radio bearer configured for bearing radio resource control message without restoring the packet data convergence protocol configuration to the radio bearer; and restoring the packet data convergence protocol configuration for radio bearers configured for small data transmission except the radio bearer configured for bearing radio resource control message.

In an eleventh aspect, there is provided a method of communication. The method comprises: receiving, at a terminal device and from a network device a packet data convergence protocol configuration for radio bearers of the terminal device; and initiating radio resource control resuming procedure for small data transmission, comprising: restoring the packet data convergence protocol configuration for radio bearers configured for small data transmission including the radio bearer configured for bearing radio resource control message.

In a twelfth aspect, there is provided a method of communication. The method comprises: generating, at network device, a packet data convergence protocol configuration for radio bearers, the radio bearers including a radio bearer configured for bearing radio resource control message, the radio bearer being configured with a default packet data convergence protocol configuration if the radio bearer is configured for small data transmission; and transmitting the packet data convergence protocol configuration to the terminal device.

In a thirteenth aspect, there is provided a terminal device. The terminal device includes a processing unit; and a memory coupled to the processing unit and storing instructions thereon, the instructions, when executed by the processing unit, causing the device to perform the method according to the first aspect.

In a fourteenth aspect, there is provided a terminal device. The terminal device includes a processing unit; and a memory coupled to the processing unit and storing instructions thereon, the instructions, when executed by the processing unit, causing the device to perform the method according to the second aspect.

In a fifteenth aspect, there is provided a terminal device. The terminal device includes a processing unit; and a memory coupled to the processing unit and storing instructions thereon, the instructions, when executed by the processing unit, causing the device to perform the method according to the third aspect.

In a sixteenth aspect, there is provided a network device. The network device includes a processing unit; and a memory coupled to the processing unit and storing instructions thereon, the instructions, when executed by the processing unit, causing the device to perform the method according to the fourth aspect.

In a seventeenth aspect, there is provided a terminal device. The terminal device includes a processing unit; and a memory coupled to the processing unit and storing instructions thereon, the instructions, when executed by the processing unit, causing the device to perform the method according to the fifth aspect.

In an eighteenth aspect, there is provided a network device. The network device includes a processing unit; and a memory coupled to the processing unit and storing instructions thereon, the instructions, when executed by the processing unit, causing the device to perform the method according to the sixth aspect.

In a nineteenth aspect, there is provided a terminal device. The terminal device includes a processing unit; and a memory coupled to the processing unit and storing instructions thereon, the instructions, when executed by the processing unit, causing the device to perform the method according to the seventh aspect.

In a twentieth aspect, there is provided a terminal device. The terminal device includes a processing unit; and a memory coupled to the processing unit and storing instructions thereon, the instructions, when executed by the processing unit, causing the device to perform the method according to the eighth aspect.

In a twenty-first aspect, there is provided a terminal device. The terminal device includes a processing unit; and a memory coupled to the processing unit and storing instructions thereon, the instructions, when executed by the processing unit, causing the device to perform the method according to the ninth aspect.

In a twenty-second aspect, there is provided a terminal device. The terminal device includes a processing unit; and a memory coupled to the processing unit and storing instructions thereon, the instructions, when executed by the processing unit, causing the device to perform the method according to the tenth aspect.

In a twenty-third aspect, there is provided a terminal device. The terminal device includes a processing unit; and a memory coupled to the processing unit and storing instructions thereon, the instructions, when executed by the processing unit, causing the device to perform the method according to the eleventh aspect.

In a twenty-fourth aspect, there is provided a terminal device. The network device includes a processing unit; and a memory coupled to the processing unit and storing instructions thereon, the instructions, when executed by the processing unit, causing the device to perform the method according to the twelfth aspect.

In a nineteenth aspect, there is provided a computer readable medium having instructions stored thereon, the instructions, when executed on at least one processor, causing the at least one processor to carry out the method according to any of the above first to twelfth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIGS. 1A and 1B illustrate conventional signaling flows for SDT;

FIG. 2 illustrates an example communication environment in which example embodiments of the present disclosure can be implemented;

FIG. 3 illustrates a signaling flow for handling the arriving of data from radio bearers not supporting transmission in inactive state according to some embodiments of the present disclosure;

FIGS. 4A and 4B illustrate example methods for handling the arriving of data from radio bearers not supporting transmission in inactive state according to some embodiments of the present disclosure;

FIGS. 5A and 5B illustrate example signaling flows for avoiding key stream reusing according to some embodiments of the present disclosure;

FIGS. 6A and 6B illustrate example methods for avoiding key stream reusing according to some embodiments of the present disclosure;

FIGS. 7A and 7B illustrate other example other methods for avoiding key stream reusing according to some embodiments of the present disclosure;

FIGS. 8 illustrate another example signaling flow for avoiding key stream reusing according to some embodiments of the present disclosure;

FIGS. 9 illustrates another example method for avoiding key stream reusing according to some embodiments of the present disclosure;

FIGS. 10 illustrates a further example method for avoiding key stream reusing according to some embodiments of the present disclosure;

FIGS. 11 illustrates a further example method for avoiding key stream reusing according to some embodiments of the present disclosure;

FIGS. 12 illustrates an example method for cell re-selection according to some embodiments of the present disclosure;

FIGS. 13 illustrates an example method for handing PDCP configuration according to some embodiments of the present disclosure; and

FIG. 14 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any end device that may be capable of wireless communication. By way of example rather than limitation, a terminal device may also be referred to as a communication device, a user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “small data transmission data”, or “SDT data” refers to the data that could be transmitted by a terminal device in the inactive state or in an idle statue. Generally speaking, the “small data transmission data” or “SDT data” is carried in radio bearer(s) (including signalling radio bearer(s) (SRB(s)) and data radio bearer(s) (DRB(s)) which is configured to support SDT, or resulted/triggered by a service/function/application which is configured for SDT.

As used herein, the term “non-small data transmission data” or “non-SDT data” refers to the data that is not allowed to be transmitted during an SDT procedure. Generally speaking, the “non-small data transmission data” or “non-SDT data” is carried in a radio bearer(s) (including SRB(s) and DRB(s)) which is not configured to support SDT, or resulted/triggered by a service/function/application which is not configured for SDT.

As used herein, the term “non-connected state transmission” refers to any transmission that is supported/enabled to be performed when the terminal device is not in the connected state. The non-connected state transmission, includes but is not limited to, SDT, early data transmission (EDT), preconfigured uplink resource (PUR).

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IOT device or fixed IOT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As discussed above, in order to reduce power consumption for a terminal device in the wireless communication, the terminal device may be configured in some power saving states or modes. For example, a Radio Resource Control (RRC) inactive state has been proposed and defined by a work item of the 3GPP. Further, as discussed above, in order to further reduce power consumption, a solution for enabling SDT for the terminal device in the RRC inactive state is proposed by a work item of the 3GPP, such that the terminal device in the inactive RRC state may maintain the inactive RRC state while enabling a data transmission.

Generally speaking, SDT is a procedure allowing data transmission while remaining in RRC inactive state (i.e., without transitioning into RRC connection state). Further, SDT is enabled on a radio bearer basis and is initiated by the terminal device only if the data volume of UL data needed to be transmitted across all radio bearers configured for SDT is less than a data volume threshold (such as, a configured volume) and the measured Reference Signal Receiving Power (RSRP) in the cell is above a configured threshold. Due to the requirements of the data volume, SDT is proposed to be applied for some specific application scenarios. Some example application scenarios of SDT for a smart terminal device may include, but not limited to the following:
Traffic/data/packet from instant messaging services (for example, whatsapp, QQ, wechat, MSN, and the like);
Heart-beat/keep-alive traffic/data/packet from some applications (for example, instant application, email application, and the like); and
Push notifications from various applications.

Some example application scenarios of SDT for a non-smart terminal device may include, but not limited to the following:
Traffic/data/packet from wearables (for example, periodic positioning information, reference signal, and the like);
Periodic or non-Periodic traffic/data/packet from sensors (for example, temperature sample, pressure sample, and the parameter from industrial wireless sensor networks); and
Periodic meter readings from smart mete device and smart meter network device.

Currently, two solutions for enabling SDT are proposed, including random access (RA)-based SDT and configured grant (CG)-based SDT.

As for RA-based SDT, the data for SDT is transmitted by using random access procedure including 2-step based random access procedure (2-step RACH for short here) and 4-step based random access procedure (4-step RACH for short). More specifically, the first UL data is transmitted via message A of 2-step RACH procedure or message 3 of 4-step RACH procedure to the network device by the terminal device in an inactive state. As for CG-based SDT, the first UL data is transmitted in CG resource.

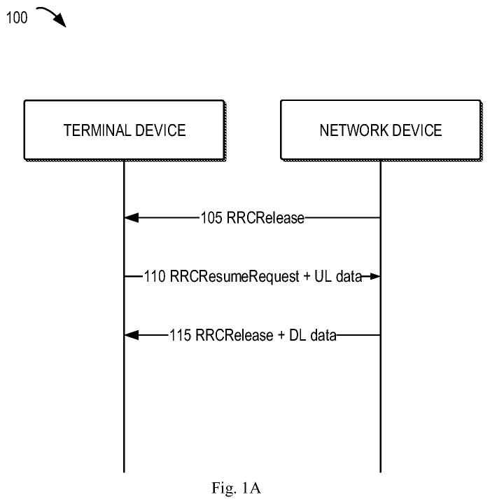

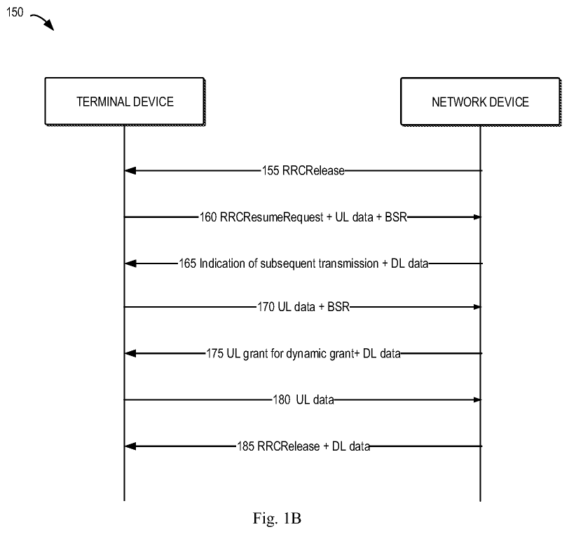

Reference is made to FIG. 1A, which shows a signaling flow 100 for one-shot SDT according to some embodiments. In operation, the network device transmits 105 an RRC release message to the terminal device. After receiving the RRC release message, the terminal device may transition into the inactive state. When the terminal device is in the inactive state and has SDT data (i.e., UL data) needed to be transmitted to the network device, the terminal device transmits 110 an RRCResumeRequest message to the network device. The UL data may be transmitted together with the RRCResumeRequest. The network device transmits 115 an RRCRelease message to the terminal device. Additionally, the network device may transmit DL data (if there is) together with the RRCRelease message to the terminal device.

In addition to the above one-shot SDT procedure, the terminal device may send/receive multiple UL and DL packets as part of the same SDT procedure and without transitioning to RRC connected state when the terminal device is in the RRC inactive state.

Reference is made to FIG. 1B, which shows a signaling flow 150 for an SDT procedure including an initial data transmission and subsequent data transmissions according to some embodiments. As illustrated in FIG. 1B, the network device transmits 155 an RRC release message to the terminal device. After receiving the RRC release message, the terminal device may transition into the inactive state. Then, if the terminal device needs to transmit UL data to the network device, the terminal device transmits 160 an RRCResumeRequest message and the UL data to the network device. Further, the terminal device also transmitted a buffer status report (BSR) together with the RRCResumeRequest message, where the BSR indicates that there is still remaining data needed to be transmitted to the network device. With the BSR from the terminal device, the network device would be informed that there is still remaining data needed to be transmitted by the terminal device. The network device may respond 165 an indication of subsequent transmission to the terminal device, where the indication could be explicit RRC message or implicit message (for example, UL grant for further transmission). Additionally, the network device may transmit DL data if there is to the terminal device.

In the following, the terminal device transmits 170 UL data and a further BSR to the network device and the network device transmit 175 an UL grant for dynamic grant and an additional DL data if there is to the terminal device accordingly. After that, the terminal device transmits 180 UL data to the network device. For the specific example of FIG. 1B, as there is no remaining data to be transmitted, the terminal device does not transmit a BSR to the network device. Accordingly, in view of the absence of BSR, the network device may transmit 185 an RRCRelease message and additional DL data to the terminal device.

Although some discussions/agreements for SDT have been made, there are still some pending issues needed to be discussed and addressed. For example, it is desirable to propose and discuss technical details about how to handle an arriving of data from RBs not supporting transmission in inactive state during an RRC connection release procedure, how to avoid key stream reusing, how to avoid cell re-selection during SDT, and how to restore the PDCP configuration (especially for SRB1 and radio bearers configured with SDT).

In the following, the SDT procedure is discussed in the example scenario that the terminal device in the inactive state. However, such specific example scenario should be considered as a limitation the present disclosure. It should be understood of the SDT is supported/enabled in idle state, the example embodiments discussed herein also may be applied to the scenario that the terminal device in the idle state.

In the following, an SDT procedure will be used as an example of a transmission procedure for describing some example embodiments of the present disclosure. It is to be understood that example embodiments of the present disclosure are equally applicable to other non-connected state transmission (such as, EDT or PUR).

In the following, in case that the non-connected state transmission is EDT or PUR, operation of going/transitioning into the idle state refers to going/transitioning to the idle state without RRC suspension. In case that the non-connected state transmission is SDT, operation of going/transition into the idle state refers to going/transitioning into RRC idle state.

In the following, the phrases (and their equivalent expressions) of “RBs not supporting transmission in inactive state” and “RBs not configured for SDT” can be used interchangeably, while the phrases (and their equivalent expressions) of “RBs supporting transmission in inactive state” and “RBs configured for SDT” can be used interchangeably.

In the following, the phrases (and their equivalent expressions) of “performing SDT”, “during SDT” and “timer for SDT being running” can be used interchangeably.

Further, in the following, when descripting the data to be processed, the phrases (and their equivalent expressions) of “packet data convergence protocol (PDCP) packet”, “PDCP data”, “PDCP protocol data unit (PDU)”, “PDCP service data unit (SDU)” can be used interchangeably.

In addition, in the following, when descripting the data to be processed, the phrases (and their equivalent expressions) of “radio link control (RLC) packet”, “RLC data”, “RLC PDU”, “RLC SDU” can be used interchangeably.

Moreover, in the following, operations discussed in some specific examples/cases/embodiments are only for the purpose of illustration without suggesting any limitations. That is, such operations are not necessarily referring to the same examples/cases/embodiments. Further, when a particular example/case/embodiment is described in connection with an example/case/embodiment, it is submitted that it is within the knowledge of one skilled in the art to affect such operation in connection with other embodiments whether or not explicitly described. In addition, it is to be understood that although examples/cases/embodiments are discussed in separate, such examples/cases/embodiments may be combined in any suitable manner.

### Example Environment

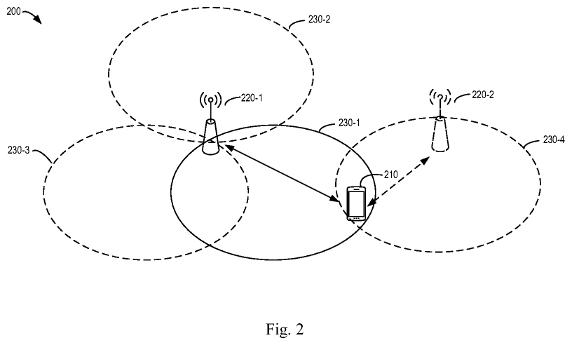

FIG. 2 shows an example communication environment 200 in which example embodiments of the present disclosure can be implemented. The network communication 200 includes a terminal device 210 and network devices 220-1 and 220-2 serving the terminal device 210. In the following text, the network device 220-1 and 220-2 are collectively referred to as the network devices 220 or individually referred to as the network device 220). Additionally, the network devices 220 may provide more than one serving area to the terminal device 210. In the specific example of FIG. 2, the network device 220-1 provides cells 230-1, 230-1 and 230-3 and the network device 220-2 provides cell 230-4. Cells 230-1 to 230-4 hereinafter are collectively referred to as the serving cells 230 or individually referred to as a serving cell 230.

In the communication environment 200, a link from the terminal device 210 to the network device 220 is referred to as an UL, while a link from the network device 220 to the terminal device 210 is referred to as a DL. In DL, the network device 220 is a transmitting (TX) device (or a transmitter) and the terminal device 210 is a receiving (RX) device (or a receiver). In UL, the terminal device 210 is a TX device (or a transmitter) and the network device 220 is a RX device (or a receiver).

In the specific example of FIG. 2, the terminal device 210 may be in different states (such as, connected state, inactive state and idle state). When the terminal device 210 is in connected state, the terminal device 210 can perform transmission of data from all radio bearers. Further, in some embodiments, when the terminal device 210 is in idle state, the terminal device usually is not allowed to perform any data transmission except specific scenario (such as, EDT or PUR). In addition, when the terminal device 210 is in the inactive state, an SDT is supported while a transmission of data not configure with SDT is not allowed during an SDT procedure. Further, a terminal device 210 in the inactive/idle state may transition into the connecting state by resuming/establishing an RRC connection with the network device 220. Such transition procedures may be initiated by either the terminal device 210 or the network device 220.

In addition, in the example of FIG. 2, the terminal device 210 may move over time. As illustrated in FIG. 2, the terminal device 210 locates at different positions over time. When moving, the terminal device 210 may communicate with different cells 230 or different network devices 220, which may be implemented by such as cell re-selection procedure or handover procedure.

The communications in the communication environment 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

It is to be understood that the numbers and their connections of network device, terminal device and cell are only for the purpose of illustration without suggesting any limitations. The communication environment 200 may include any suitable network device, terminal device and cell adapted for implementing embodiments of the present disclosure. Although not shown, it is to be understood that one or more additional terminal devices may be located in the respective cells. It would also be appreciated that in some examples, only the homogeneous network deployment or only the heterogeneous network deployment may be included in the communication environment 200.

### Example Processes for Indicating the Arriving of Data From RBs Not Supporting Transmission in Inactive State

As discussed above, due to the requirements of the data volume, SDT is proposed to be applied for merely some specific application scenarios/RBs. Further, during SDT, if the terminal device determines that there is data from the RBs nor support transmission in inactive state (such as, non SDT data) needed to be transmitted to the network device, the terminal device should indicate the arriving of data from the RBs not supporting transmission in inactive state to the network device, because the rom the RBs nor support transmission in inactive state (such as, non SDT data) may include important/emergency data or information. Further, during SDT, the network device may transmit an RRC release message to the terminal device. For example, the network device determines to end the current SDT procedure.

Currently, when the terminal device receives an RRC release message, the terminal device doesn't perform the RRC connection release procedure immediately, instead the terminal device will wait for a period (such as, 60 ms) or optionally when lower layers of the terminal device indicate that the receipt of the RRC release message has been successfully acknowledged. Specifically, it has been reached an agreement that if the terminal device receives an RRC release message, the terminal device should delay some actions within 60 ms or optionally when lower layers of the terminal device indicate that the receipt of the RRC release message has been successfully acknowledged. The actions to be delayed comprise for example: stopping timer T380, if running; stopping timer T320, if running; if timer T316 is running, stopping timer T316 and clearing the information included in VarRLF-Report, if any, and stopping timer T350, if running; and other stipulated actions.

Generally speaking, the terminal device's behavior under different scenarios should be aligned or similar. In order to align the terminal device's behavior in SDT scenario and connected state transmission scenario, it is expected that the above RRC connection release procedure in connected state transmission scenario can be reused in the SDT scenario. If so, as for the SDT scenario, the RRC layer/entity of the terminal device will defer/delay the above actions for 60 ms from the moment the RRC release message was received or optionally when lower layers indicate that the receipt of the RRC release message has been successfully acknowledged. Therefore, during SDT, if the terminal device receives an RRC release message, the terminal device still maintains at SDT status for a period. During this period, the terminal device may occur data from the RBs nor support transmission in inactive state (such as, non SDT data). So far, no discussion haven been made about how to indicate the arriving of data from the RBs not supporting transmission in inactive state during this period (i.e., during an RRC connection release procedure when the terminal device performing an SDT with a network device).

In the following text, some example embodiments to address this pending issue will be discussed in detail.

### Example Embodiments for Disabling Indicating the Arriving of Data From RBs Not Supporting Transmission in Inactive State

In accordance with some example embodiments of the present disclosure, there is provided a solution for communication. In this solution, the terminal device 210 doesn't indicate the arriving of data from RBs not supporting transmission in inactive state during an RRC connection release procedure (such as, after reviving an RRC release message during an SDT). In other words, if data from RBs not supporting transmission in active state arrives during SDT and RRC release message is not received yet, the terminal device 210 may indicate the arriving of data from RBs not supporting transmission in inactive state to the network device 220. In this way, the RRC connection release procedure may be completed without any disturbing, and the state between the terminal device 210 and the network device 220 may be consistent.

The terminal device 210 may indicate the arriving of data from RBs not supporting transmission in inactive state to the network device 220 in any suitable manner. In one example, the terminal device 210 transmits a dedicated control channel (DCCH) message (SRB1) to the network device 220. In another example, the terminal device 210 a MAC CE to the network device 220. In a further example, the terminal device 210 initiate an RRC connection resume procedure with the network device 220. During the RRC connection resume procedure, the terminal device 210 may transmit a common control channel (CCCH) message (SRB0) to the network device 220.

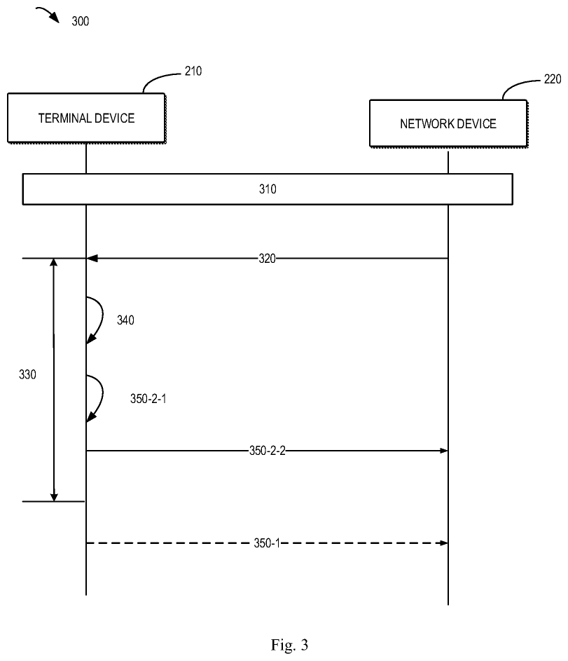

Reference is now made to FIG. 3, which shows a signaling flow 300 for handling the arriving of data from RBs not supporting transmission in inactive state according to some embodiments of the present disclosure. For the purpose of discussion, the signaling flow 300 will be described with reference to FIG. 2. The signaling flow 300 may involve a network device 220 and a terminal device 210.

In operation, the terminal device 210 is performing 310 a SDT with the network device 220. During the SDT, the terminal device 210 initiates an RRC connection release procedure. In some example embodiments, when the terminal device 210 receives an RRC release message, the terminal device 210 will defer/delay related operations (such as, stopping corresponding timer) for a period 330. The period 330 may be a pre-defined/pre-configured value (such as, 60 ms). Alternatively, the period 330 refers to the period from the time point of receipt of the RRC release message to the time point that lower layers of the terminal device 210 indicate that the receipt of the RRC release message has been successfully acknowledged. As illustrated in FIG. 3, during this period 330, the terminal device 210 determines/detects 340 an arriving of data from RBs not supporting transmission in inactive state.

In some example embodiments, the terminal device 210 disables indicating the arriving of data from RBs not supporting transmission in inactive state to the network device 220 during the RRC release procedure after receiving the RRC release message.

Further, in some example embodiments, the terminal device 210 may start a timer in response to initiating the SDT and stops the timer immediately in response to receiving an RRC release message from the network device 220. In this event, in case that the terminal device 210 determines that there is data from the RBs nor support transmission in inactive state (such as, non SDT data) needed to be transmitted to the network device 220, the terminal device 210 may determine whether the timer is ruing. If the timer is running (which means that the terminal device 210 has not received the RRC release message yet) and data form the RBs not supporting transmission in inactive state arrives, the terminal device 210 indicates the arriving of data from RBs not supporting transmission in inactive state to the network device 220. Otherwise, if the timer is not running (which means that the terminal device 210 receives the RRC release message), the terminal device 210 disables indicating the arriving of data from RBs not supporting transmission in inactive state to the network device 220.

In summary, in some example embodiments, if the timer for SDT is running (which means that the RRC release message is not received yet) and if data from the RBs not supporting transmission in inactive state arrives, the terminal device 210 can indicate the arriving of data from RBs not supporting transmission in inactive state to the network device 220. Otherwise, the terminal device 210 will not indicate the arriving of data from RBs not supporting transmission in inactive state to the network device 220.

In addition, in some example embodiments, the terminal device 210 indicates 350-1 the arriving of data from RBs not supporting transmission in inactive state to the network device 220 in response to a completion of the RRC release procedure. In this way, the arriving of data from RBs not supporting transmission in inactive state may be indicated to the network device 220 without a significant delay.

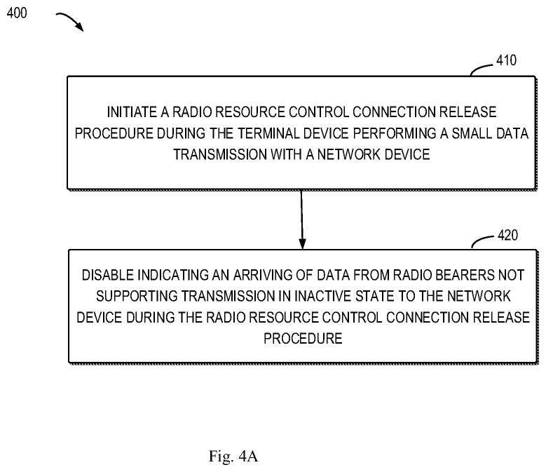

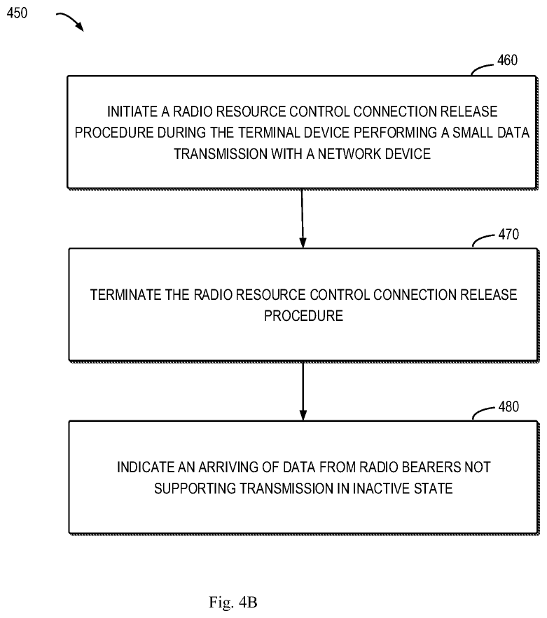

FIG. 4A illustrates a flowchart of an example method 400 in accordance with some embodiments of the present disclosure. For example, the method 400 can be implemented at the terminal device 210 as shown in FIG. 2.

At block 410, the terminal device 210 initiates an RRC release procedure during the terminal device 210 performing an SDT with a network device 220.

At block 420, the terminal device 210 disables indicating an arriving of data from RBs not supporting transmission in inactive state to the network device 220 during the RRC connection release procedure.

In some example embodiments, the terminal device 210 indicates the arriving of data from RBs not supporting transmission in inactive state to the network device 220 in response to a timer being running, wherein the timer is started in response to initiating the SDT and stopped in response to receiving an RRC release message from the network device 220.

In some example embodiments, the terminal device 210 enables indicating the arriving of data from RBs not supporting transmission in inactive state to the network device 220 in response to a completion of the RRC connection release procedure.

In some example embodiments, the terminal device 210 comprises circuitry configured to initiates an RRC release procedure during the terminal device 210 performing an SDT with a network device 220. The circuitry is further configured to disables indicating an arriving of data from RBs not supporting transmission in inactive state to the network device 220 during the RRC connection release procedure.

In some example embodiments, the circuitry is further configured to indicate the arriving of data from RBs not supporting transmission in inactive state to the network device 220 in response to a timer being running, wherein the timer is started in response to initiating the SDT and stopped in response to receiving an RRC release message from the network device 220

In some example embodiments, the circuitry is further configured to enables indicating the arriving of data from RBs not supporting transmission in inactive state to the network device 220 in response to a completion of the RRC connection release procedure.

### Example Embodiments for Indicating the Arriving of Data From RBs Not Supporting Transmission in Inactive State

Alternatively, in accordance with some example embodiments of the present disclosure, there is provided a solution for communication. In this solution the terminal device 210 may abandon/terminate the RRC connection release procedure and indicate the arriving of data from RBs not supporting transmission in inactive state to the network device 220 immediately. In summary, if data from the RBs not supporting transmission in inactive state arrives after receiving the RRC release message, the terminal device 210 abandons the RRC connection release procedure and indicates the arriving of data from RBs not supporting transmission in inactive state to the network device 220. In this way, the arriving of data from RBs not supporting transmission in inactive state may be indicated to the network device 220 in time.

Reference is made to FIG. 3 again. As illustrated in FIG. 3, the terminal device 210 determines that there is data from the RBs nor support transmission in inactive state (such as, non SDT data) needed to be transmitted to the network device 220 during the RRC connection release procedure. The terminal device 210 terminates 350-2-1 the RRC connection release procedure and indicates 350-2-2 the arriving of data from RBs not supporting transmission in inactive state to the network device 220.

FIG. 4B illustrates a flowchart of an example method 450 in accordance with some embodiments of the present disclosure. For example, the method 450 can be implemented at the terminal device 210 as shown in FIG. 2.

At block 450, the terminal device 210 initiates an RRC release procedure during the terminal device 210 performing an SDT with a network device 220.

At block 460, the terminal device 210 terminates the RRC connection release procedure.

At block 470, the terminal device 210 indicates the arriving of data from RBs not supporting transmission in inactive state to the network device 220.

In some example embodiments, the terminal device 210 comprises circuitry configured to initiates an RRC release procedure during the terminal device 210 performing an SDT with a network device 220. The circuitry is further configured to terminate the RRC connection release procedure. The circuitry is also configured to indicate the arriving of data from RBs not supporting transmission in inactive state to the network device 220.

### Example Processes for Security Keys

During SDT, the terminal device may terminate/abort the SDT procedure due to some events. Such events include but not are limited to:
Event 1) Cell re-selection;
Event 2) Expiry of failure detection timer of SDT;
Event 3) Maximum number of retransmissions is reached in RLC;
Event 4) Receiving RRC reject message during SDT;
Event 5) Abortion of connection resuming procedure by upper layers;
Event 6) Receiving radio access network (RAN) paging during SDT;
Event 7) Arriving of non-SDT data/signaling at the terminal device side;
Event 8) RSRP requirement is not fulfilled during SDT; and
Event 9) Lower layer (such as, media access control (MAC) layer) indicates the abortion of SDT, e.g. due to no suitable resource.

If the SDT abortion occurs, the terminal device performs at least one of the following procedures:
Discard the current application Stratum (AS) security context including the KgNB key, KRRCenc key, the KRRCint key, the KUPint key and the KUPenc key;
Reset MAC and release default MAC cell group configuration;
Suspend SRB1 and RB(s) configured with SDT; and
   Re-establish RLC of SRB1 and other RB(s) configured with SDT.

Further, after SDT abortion, the terminal device remains at the inactive state, and may initiate a further RRC resume procedure in the same cell again. However, as discussed above, the current AS security context has been discarded during the SDT abortion procedure. Even if assumes that the AS security context may be remained and the terminal device may initiate a further RRC resume procedure by using the same UE context (such as, AS security context) later, it is still undesirable and unexpected, because reusing the same AS security context during the further RRC resume procedure may cause that different packets in the following RRC connection resume procedure are ciphered using the same security key and same count value.

In one possible solution, it is proposed that the serving gNB provides a new security element (such as, NextHopChainingCount, referred to as NCC herein) for generating new security key and inactive-radio network temporary identifier (I-RNTI) upon initiating any SDT for future using. However, this solution is not feasible if the SDT aborts before receiving the first downlink transmission.

In another possible solution, it is proposed that the network device provides new NCC/RNTI immediately after an abrupt termination of the SDT session. However, the network derive cannot provide new security elements/keys immediately because sometimes the network device does not know whether an SDT abortion has occurred.

### Example Embodiments for Providing a Plurality of Security Elements

In accordance with some example embodiments of the present disclosure, there is provided a solution for communication. In this solution, the terminal device 210 may be provide with new key information (such as, a plurality of security elements for deriving a plurality of respective security keys for communication between the terminal device 210 and the network device 220 when the terminal device 210 is in a non-connected state). In this way, after SDT abortion, the terminal device 210 may initiate at least one further RRC connection resume procedure with the new security key(s). As a result, the key stream reuse issues discussed above can be avoided and the security communication with the network device 220 is ensured thereby.

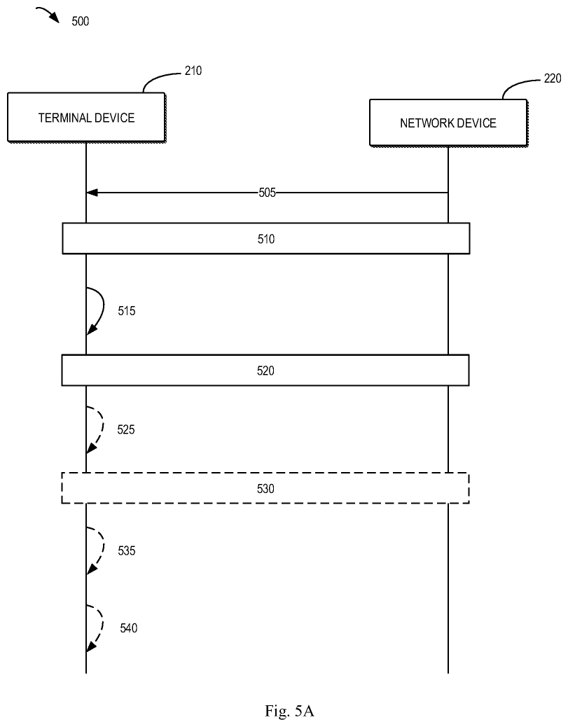

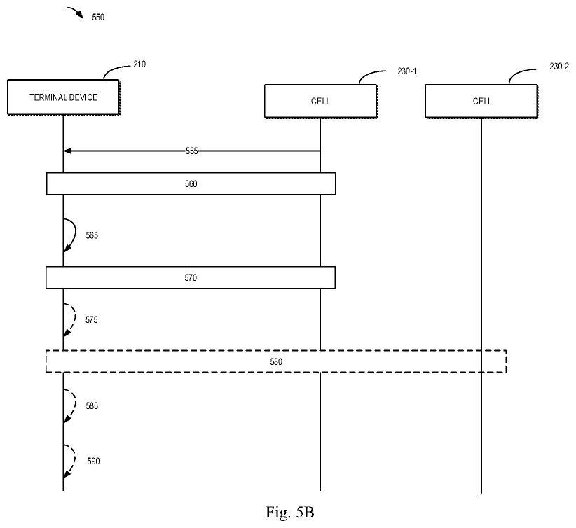

Reference is now made to FIG. 5A, which shows a signaling flow 500 for avoiding key stream reusing according to some embodiments of the present disclosure. For the purpose of discussion, the signaling flow 500 will be described with reference to FIG. 2. The signaling flow 500 may involve a network device 220 and a terminal device 210.

In operation, the terminal device 210 receives 505 a message comprising a plurality of security elements for deriving a plurality of respective security keys for communication between the terminal device 210 and the network device 220 when the terminal device 210 is in a non-connected state from the network device 220.

In some example embodiments, the message comprising the plurality of security elements is an RRC release message comprises a configuration for non-connected transmission. One example of the non-connected state transmission is SDT. Another example of the non-connected state transmission is EDT. A further example of the non-connected state transmission is PUR.

With the plurality of security elements, the terminal device 210 may perform RRC connection resume procedures with the network device 220 when the terminal device 210 is in the non-connected state. In addition, in some example embodiments, the RRC connection resume procedures may associate with at least one non-connected state transmission.

In some example embodiments, the terminal device 210 performs 510 a first RRC connection resume procedure associated with a non-connected state transmission with the network device 220 by using a first security key derived from a first security element of the plurality of security elements. Further, the terminal device 210 aborts 515 the non-connected state transmission in response to detecting a pre-configured event for triggering an abortion of the non-connected state transmission. After the non-connected state transmission abortion, the terminal may initiate a further RRC connection resume procedure. Specifically, the terminal device 210 performs 520 a second RRC connection resume procedure with the network device 220 by using a second security key derived from a second security element of the plurality of security elements.

In addition, in some example embodiments, except for the first RRC connection resume, any of the RRC connection resume procedure(s) may either be a regular RRC connection resume procedure without carrying non-connected state transmission data or an RRC connection resume procedure for a non-connected state transmission. For example, the terminal device 210 may transmit an RRC resume request to the network device 220 and no data is transmitted together with the RRC resume request.

Further, in order to save effort of network device 220, the terminal device 210 can indicate information about the security element being used to the network device 220. For example, in some example embodiments, the terminal device 210 transmits a field indicating the security element being used to the network device 220. In addition, in some example embodiments, the field is a MAC CE.

In some example embodiments, the new key information (such as, a plurality of security elements) are configured by the network device 220 via an RRC release message with suspendconfig. For example, the network device 220 (such as, a gNB) configures a list of security configurations (i.e., a plurality of security elements, for example, a list of NextHopChainingCount) in RRC release message which configures SDT for the terminal device 210. The list consists of N security configurations, which can be used for at most N times of RRC connection resume procedure after SDT abortion.

As one specific example, the plurality of security elements may be a plurality of NCCs. The information about the security element being used may be represented as the number/index of the NCC being used and transmitted to the network device 220 together with the RRCResumeRequest, for example by using MAC CE.

In some example embodiments, the terminal device 210 performs different RRC connection resume procedures with the network device 220 by using different security keys derived from different security elements of the plurality of security elements in sequence, which means that the terminal device 210 may initiate a plurality of RRC connection resume procedures with the different security keys.

As one specific example of FIG. 5A, the second RRC connection resume procedure is associated with a non-connected state transmission. Then, the terminal device 210 aborts 525 the non-connected state transmission in response to detecting a pre-configured event for triggering an abortion of the non-connected state transmission. After that, the terminal device 210 initiates 530 a third RRC connection resume procedure with the network device 220.

In addition, in some example embodiments, if there is no security element (i.e., NCC) to be used, upon the pre-configured event for triggering an abortion of the non-connected state transmission happens, the terminal device 210 performs the actions of going to idle state (such as, RRC idle state). In some example embodiments, in case that the non-connected state transmission is EDT or PUR, operation of going to the idle state refers to going to the idle state without RRC suspension.

In some example embodiments, if there is no security element available for deriving security key, the terminal device 210 may transition into an idle state upon detecting a pre-configured event. Specifically, in FIG. 5A, the terminal device 210 aborts 535 the non-connected state transmission and transitions 540 into the idle state.

Further, in some example embodiments, the network device(s) 220 may provide a plurality of cells. Further, more than one cell may be combined as a serving group, and the cells in the same serving group may share the same security context. When the terminal device 210 in the inactive state moving among the cells in the same group, the terminal device 210 does not need to transition into connected state. For such scenario, the above different RRC connection resume procedures may occur in different cells.

Reference is made to FIG. 5B, which illustrates a specific example for providing a plurality of security elements. For the purpose of discussion, the signaling flow 550 will be described with reference to FIG. 2. The signaling flow 550 may involve the terminal device 210, cell 230-1 and cell 230-2. In the following text, the cell 230-1 also is referred to the first cell 230-1, while the cell 230-2 also is referred to the second cell 230-2.

In operation, the terminal device 210 receives 555 a message comprising a plurality of security elements for deriving a plurality of respective security keys for communication between the terminal device and the network device 220 when the terminal is in a non-connected state from the network device 220. For example, the terminal device 210 receives an RRC release message with suspendConfig, where the suspendConfig may comprises a plurality of NCCs (including a primary NCC (referred to as NCC0) and a list of additional NCCs (referred to as NCC1, NCC2, . . . )).

With the plurality of security elements, the terminal device 210 may perform RRC connection resume procedures with any of the cells 230-1 and 230-2. In the specific example of FIG. 5B, the terminal device 210 performs 560 a first RRC connection resume procedure associated with a non-connected state transmission with the first cell 230-1 by using a first security key derived from a first security element of the plurality of security elements. For example, the terminal device 210 initiates SDT procedure with the first cell 230-1 by using NCC0.

In the following, the terminal device 210 aborts 565 the non-connected state transmission in response to detecting a pre-configured event for triggering an abortion of the non-connected state transmission.

After the non-connected state transmission abortion, the terminal device 210 also may initiate a further RRC connection resume procedure with any of cells 230 (such as, the first cell 230-1 and the second cell 230-2). In the specific example of FIG. 5B, the terminal device 210 performs 570 a second RRC connection resume procedure associated with a further non-connected state transmission with the first cell 230-1 by using a second security key derived from a second security element of the plurality of security elements. For example, the terminal device 210 initiates an RRC connection resume procedure with the first cell 2130-1 using new security key generated by NCC1.

Then, the terminal device 210 aborts 575 the further non-connected state transmission in response to detecting a pre-configured event for triggering an abortion of the non-connected state transmission for example due to cell re-selection.

If there is security element available for deriving security key, the terminal device 210 may initiate 580 a third RRC connection resume procedure with any of cells 230 (such as, the first cell 230-1 and the second cell 230-2). In the specific example of FIG. 5B, the terminal device 210 performs 580 a third RRC connection resume procedure associated with a non-connected state transmission with the second cell 230-2 by using a third security key derived from a third security element of the plurality of security elements. For example, the terminal device 210 initiates an RRC connection resume procedure with the second cell 2130-1 using new security key generated by NCC2.

In some example embodiments, if there is no security element available for deriving security key, the terminal device 210 transitions into an idle state upon detecting a pre-configured event. Specifically, in FIG. 5B, the terminal device 210 aborts 585 the non-connected state transmission and transitions 590 into the idle state.

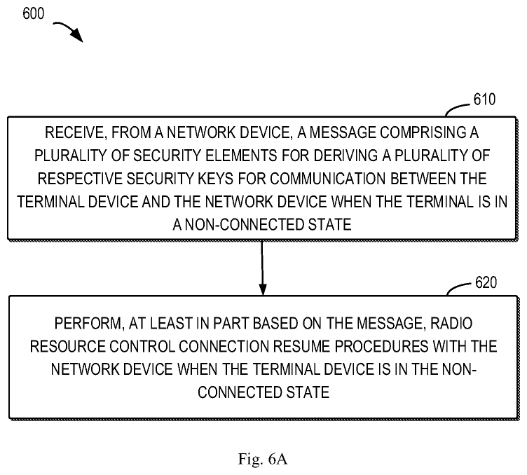

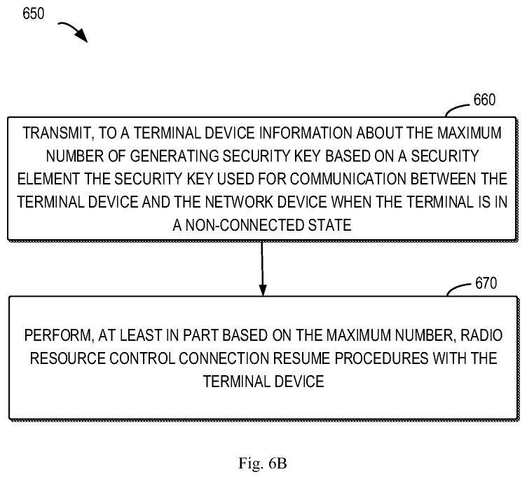

FIG. 6A illustrates a flowchart of an example method 600 in accordance with some embodiments of the present disclosure. For example, the method 600 can be implemented at the terminal device 210 as shown in FIG. 2.

At block 610, the terminal device 210 receives, from a network device 220, a message comprising a plurality of security elements for deriving a plurality of respective security keys for communication between the terminal device 210 and the network device 220 when the terminal is in a non-connected state.

At block 620, the terminal device 210 performs, at least in part based on the message, RRC connection resume procedures with the network device 220 when the terminal device 210 is in the non-connected state.

In some example embodiments, the message is an RRC release message comprising a configuration for non-connected transmission.

In some example embodiments, the terminal device 210 performs a first RRC connection resume procedure associated with a non-connected state transmission with the network device 220 by using a first security key derived from a first security element of the plurality of security elements. Then, the terminal device 210 aborts the non-connected state transmission in response to detecting a pre-configured event for triggering an abortion of the non-connected state transmission. Further, the terminal device 210 performs a second RRC connection resume procedure with the network device 220 by using a second security key derived from a second security element of the plurality of security elements.

In some example embodiments, if there is no security element available for deriving security key, the terminal device 210 transitions into an idle state upon detecting a pre-configured event.

In some example embodiments, the terminal device 210 transmits a field indicating the security element being used to the network device 220.

In some example embodiments, the field is a MAC CE.

In some example embodiments, the terminal device 210 comprises circuitry configured to receive, from a network device 220, a message comprising a plurality of security elements for deriving a plurality of respective security keys for communication between the terminal device 210 and the network device 220 when the terminal is in a non-connected state. The circuitry further configured to perform, at least in part based on the message, RRC connection resume procedures with the network device 220 when the terminal device 210 is in the non-connected state.

In some example embodiments, the message is an RRC release message comprising a configuration for non-connected transmission.

In some example embodiments, the circuitry further configured to perform a first RRC connection resume procedure associated with a non-connected state transmission with the network device 220 by using a first security key derived from a first security element of the plurality of security elements, abort the non-connected state transmission in response to detecting a pre-configured event for triggering an abortion of non-connected state transmission, and perform a second RRC connection resume procedure with the network device 220 by using a second security key derived from a second security element of the plurality of security elements.

In some example embodiments, the circuitry further configured to transition into an idle state upon detecting a pre-configured event, if there is no security element available for deriving security key.

In some example embodiments, the circuitry further configured to transmit a field indicating the security element being used to the network device 220.

In some example embodiments, the field is a MAC CE.

FIG. 6B illustrates a flowchart of an example method 650 in accordance with some embodiments of the present disclosure. For example, the method 650 can be implemented at the network device 220 as shown in FIG. 2.

At block 660, the network device 220 transmits, to a terminal device 210, a message comprising a plurality of security elements for deriving a plurality of respective security keys for communication between the terminal device 210 and the network device 220 when the terminal device 210 is in a non-connected state.

At block 670, the network device 220 performs at least in part based on the message, RRC connection resume procedures with the terminal device 210 when the terminal device 210 is in the non-connected state.

In some example embodiments, the message is an RRC release message comprising a configuration for non-connected transmission.

In some example embodiments, the network device 220 receives a field indicating the security element being used from the terminal device 210.

In some example embodiments, the field is a MAC CE.

In some example embodiments, the network device 220 comprises circuitry configured to transmit, to a terminal device 210, a message comprising a plurality of security elements for deriving a plurality of respective security keys for communication between the terminal device 210 and the network device 220 when the terminal device 210 is in a non-connected state. The circuitry further configured to perform at least in part based on the message, RRC connection resume procedures with the terminal device 210 when the terminal device 210 is in the non-connected state.

In some example embodiments, the message is an RRC release message comprising a configuration for non-connected transmission.

In some example embodiments, the circuitry further configured to receive a field indicating the security element being used from the terminal device 210.

In some example embodiments, the field is a MAC CE.

### Example Embodiments for Indicating the Maximum Number of Generating Security Key

In accordance with some example embodiments of the present disclosure, there is provided a solution for communication. In this solution, the terminal device 210 is provided with the maximum number of generating security key based on a security element. Thus, the terminal device 210 may use the same security element to generate different security keys such as by using horizontal key derivation. In this way, after SDT abortion, the terminal device 210 may initiate a further RRC connection resume procedure with new security key. As a result, the key stream reuse issues discussed above can be avoided and the security communication with the network device 220 is ensured thereby.

In summary, the terminal device 210 uses a horizontal key derivation for the recovery mechanism (such as, RRC connection resume procedures) after an abrupt termination of an SDT session (such as, an SDT abortion). The terminal device 210 uses a horizontal key derivation for initiating RRC connection resume procedure after SDT abortion.

In some example embodiments, the horizontal key derivation can be performed X times (i.e., the maximum number), which also means that X times of SDT abortion can be performed. The maximum number (X) can be predetermined number. In some example embodiments, if the number of SDT abortion arrives at the maximum number, upon the pre-defined events for triggering SDT abortion happen, the terminal device 210 performs the actions of going to idle state (such as RRC idle state).

Details will be described with reference to FIG. 5A again. In operation, the terminal device 210 receives 505 information about the maximum number of generating security key based on a security element. The security key is to be used for communication between the terminal device 210 and the network device 220 when the terminal device 210 is in a non-connected state from the network device 220.

In some example embodiments, the maximum number is transmitted via a message comprising a configuration for non-connected transmission. One example of the non-connected state transmission is SDT. Another example of the non-connected state transmission is EDT. A further example of the non-connected state transmission is PUR.

In some example embodiments, the terminal device 210 performs, at least in part based on the maximum number, RRC connection resume procedures with the network device 220 when the terminal device 210 is in the non-connected state.

In addition, in some example embodiments, during the RRC connection resume procedure and/or following data transmissions, data may use new security key but a message authentication for integrity (such as, MAC-I) may still be calculated based on the stored key).

In some example embodiments, the terminal device 210 performs 510 a first RRC resume procedure associated with a non-connected state transmission with the network device 220 by using a first security key generated based on the security element. Further, the terminal device 210 aborts 515 the non-connected state transmission in response to detecting a pre-configured event for triggering an abortion of non-connected state transmission. After the non-connected state transmission abortion, the terminal may initiate a further RRC connection resume procedure. Specifically, the terminal device 210 performs 520 a second RRC connection resume procedure with the network device 220 by using a second security key generated based on the security element. The second security key is different from the first security key.

Further, in order to save effort of network device 220, the terminal device 210 can indicate information about the number of generating security key based on the security element to the network device 220. For example, in some example embodiments, the terminal device 210 transmits a field indicating the number of generating security key based on the security element to the network device 220. In addition, in some example embodiments, the field is a MAC CE. As one example, the terminal device 210 sends the number of horizontal key update times to the network device 220 together with an RRC resume request message, for example by MAC CE.

As one specific example of FIG. 5A, the second RRC connection resume procedure is associated with a non-connected state transmission. Then, the terminal device 210 aborts 525 the non-connected state transmission in response to detecting a pre-configured event for triggering an abortion of non-connected state transmission.

In addition, in some example embodiments, if a number of generating security key based on the security element is below the maximum number, the terminal device 210 may initiate another RRC connection resume procedure again. As illustrated in FIG. 5A, the terminal device 210 initiates 530 a third RRC connection resume procedure with the network device 220.

In addition, if the number of generating security key based on the security element arrives at the maximum number, the terminal device 210 transitions into an idle state upon detecting a pre-configured event. Specifically, in FIG. 5A, the terminal device 210 aborts 535 the non-connected state transmission and transitions 540 into an idle state.

Further, the above discussed processed also may be applied to the scenario where the network device(s) 220 may provide a plurality of cells 230. One specific example process will be discussed with reference to FIG. 5B.

In operation, the terminal device 210 receives 555 information about the maximum number. For example, the terminal device 210 receives an RRC release message with suspendConfig. In particular, the RRC release message comprises a NCC and the maximum number (X).

In the specific example of FIG. 5B, the terminal device 210 performs 560 a first RRC connection resume procedure associated with a non-connected state transmission with the first cell 230-1 by using a first security key a first security key generated based on the security element (i.e., the NCC). For example, the terminal device 210 initiates SDT procedure with the first cell 230-1 using the NCC.

In the following, the terminal device 210 aborts 565 the non-connected state transmission in response to detecting a pre-configured event for triggering an abortion of non-connected state transmission.

After the non-connected state transmission abortion, the terminal device 210 also may initiate a further RRC connection resume procedure with any of cells 230 (such as, the first cell 230-1 and the second cell 230-2). In the specific example of FIG. 5B, the terminal device 210 performs 570 a second RRC connection resume procedure associated with a non-connected state transmission with the first cell 230-1 by using a second security key.

For example, the terminal device 210 initiates a second RRC connection resume procedure with the first cell 230-1 using new key generated by the horizontal derivation.

Then, the terminal device 210 aborts 575 the non-connected state transmission in response to detecting a pre-configured event for triggering an abortion of non-connected state transmission for example due to cell re-selection.

If a number of generating security key based on the security element is below the maximum number, the terminal device 210 may initiate 580 a third RRC connection resume procedure with any of cells 230 (such as, the first cell 230-1 and the second cell 230-2). In the specific example of FIG. 5B, the terminal device 210 performs 580 a third RRC connection resume procedure associated with a non-connected state transmission with the second cell 230-2 by using a third security key.

For example, the terminal device 210 initiates the third RRC connection resume procedure with the second cell 230-2 using new key generate by the horizontal derivation.

In some example embodiments, if the number of generating security key based on the security element arrives at the maximum number, the terminal device 210 transitions into an idle state upon detecting a pre-configured event. Specifically, in FIG. 5B, the terminal device 210 aborts 585 the non-connected state transmission and transitions 590 into an idle state.

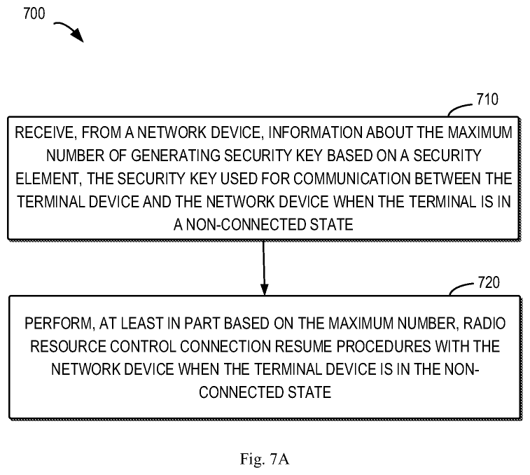

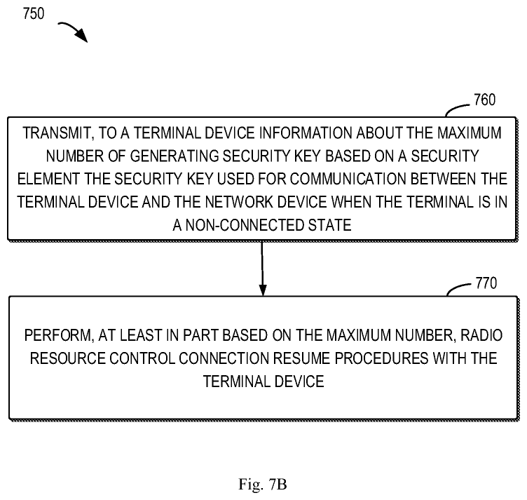

FIG. 7A illustrates a flowchart of an example method 700 in accordance with some embodiments of the present disclosure. For example, the method 700 can be implemented at the terminal device 210 as shown in FIG. 2.

At block 710, the terminal device 210 receives, from a network device 220, information about the maximum number of generating security key based on a security element, the security key used for communication between the terminal device 210 and the network device 220 when the terminal device 210 is in a non-connected state.

At block 720, the terminal device 210 performs, at least in part based on the maximum number, RRC connection resume procedures with the network device 220 when the terminal device 210 is in the non-connected state.

In some example embodiments, the maximum number is transmitted via a message comprising a configuration for non-connected transmission.

In some example embodiments, the terminal device 210 performs a first RRC connection resume procedure associated with a non-connected state transmission with the network device 220 by using a first security key generated based on the security element. Further, the terminal device 210 aborts the non-connected state transmission in response to detecting a pre-configured event for triggering an abortion of non-connected state transmission. Then, the terminal device 210 performs a second RRC connection resume procedure with the network device 220 by using a second security key generated based on the security element.

In some example embodiments, the terminal device 210 transitions into an idle state upon detecting a pre-configured event, if a number of generating security key based on the security element arrives at the maximum number.

In some example embodiments, the terminal device 210 transmits a field indicating the number of generating security key based on the security element to the network device 220.

In some example embodiments, the field is a MAC CE.

In some example embodiments, the terminal device 210 comprises circuitry configured to receive, from a network device 220, information about the maximum number of generating security key based on a security element, the security key used for communication between the terminal device 210 and the network device 220 when the terminal device 210 is in a non-connected state. The circuitry is further configured to perform, at least in part based on the maximum number, RRC connection resume procedures with the network device 220 when the terminal device 210 is in the non-connected state.

In some example embodiments, the maximum number is transmitted via a message comprising a configuration for non-connected transmission.

In some example embodiments, the circuitry is further configured to perform a first RRC connection resume procedure associated with a non-connected state transmission with the network device 220 by using a first security key generated based on the security element, aborts the non-connected state transmission in response to detecting a pre-configured event for triggering an abortion of non-connected state transmission and perform a second RRC connection resume procedure with the network device 220 by using a second security key generated based on the security element.

In some example embodiments, the circuitry is further configured to transition into an idle state upon detecting a pre-configured event, if a number of generating security key based on the security element arrives at the maximum number.

In some example embodiments, the circuitry is further configured to transmit a field indicating the number of generating security key based on the security element to the network device 220.

In some example embodiments, the field is a MAC CE.

FIG. 7B illustrates a flowchart of an example method 750 in accordance with some embodiments of the present disclosure. For example, the method 750 can be implemented at the network device 220 as shown in FIG. 2.

At block 760, the network device 220 transmits, to a terminal device 210 information about the maximum number of generating security key based on a security element the security key used for communication between the terminal device 210 and the network device 220 when the terminal device 210 is in a non-connected state.

At block 770, the network device 220 performs, at least in part based on the maximum number, RRC connection resume procedures with the terminal device 210.

In some example embodiments, the maximum number is transmitted via a message comprising a configuration for non-connected transmission.

In some example embodiments, the network device 220 receives from the terminal device 210, a field indicating the number of generating security key based on the security element.

In some example embodiments, the field is a MAC CE.

In some example embodiments, the network device 220 comprises circuitry configured to transmit, to a terminal device 210 information about the maximum number of generating security key based on a security element the security key used for communication between the terminal device 210 and the network device 220 when the terminal device 210 is in a non-connected state. The circuitry is further configured to perform, at least in part based on the maximum number, RRC connection resume procedures with the terminal device 210.

In some example embodiments, the maximum number is transmitted via a message comprising a configuration for non-connected transmission.

In some example embodiments, the circuitry is further configured to receive from the terminal device 210, a field indicating the number of generating security key based on the security element.

In some example embodiments, the field is a MAC CE.

### Example Embodiments for Discarding Stored Data

Further, in addition to obtaining new security keys by a plurality of security elements or obtaining new security key based on same security element by such as a horizontal key derivation, the sequence number (such as, TX_NEXT/COUNT) also be used to ensuring the security communication between the terminal device 210 and the network device 220. In addition, the terminal device 210 also needs to discard stored data (such as, PDCP PDUs) configured for non-connected state transmission. The detailed operation will be discussed below.

In accordance with some example embodiments of the present disclosure, there is provided a solution for communication. In this solution, the terminal device 210 performs non-connected state transmission with a first cell (such as, 230-1) of a network device 220 by encrypting data with a first sequence number. The method further comprises discarding stored data for radio bearers configured for non-connected state transmission after detecting a pre-configured event for triggering abortion of non-connected state transmission. After that, the terminal device 210 performs an RRC connection resume procedure with the first cell or the second cell with the first sequence number without initialization or the initialized first sequence number.

In this way, the communication between the terminal device 210 and the network device 220 is ensured without any additional operation at the network device 220.

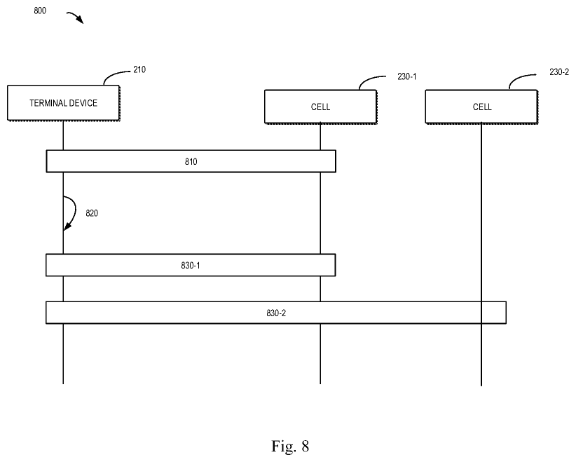

Reference is now made to FIG. 8, which shows a signaling flow 800 for avoiding key stream reusing according to some embodiments of the present disclosure. For the purpose of discussion, the signaling flow 800 will be described with reference to FIG. 2. The signaling flow 800 may involve the terminal device 210, cell 230-1 and cell 230-2. In the following text, the cell 230-1 also is referred to the first cell 230-1, while the cell 230-2 also is referred to the second cell 230-2.

In operation, the terminal device 210 performs 810 a non-connected state transmission with a first cell of 230-1 a network device 220 by encrypting data with a first sequence number. One example of the non-connected state transmission is SDT. Another example of the non-connected state transmission is EDT. A further example of the non-connected state transmission is PUR.

Further, in some example embodiments, the first sequence number may be a PDCP PDU specific number, for example, TX_NEXT/COUNT.

The terminal device 210 discards 820 the stored data for RBs configured for non-connected state transmission after detecting a pre-configured event for triggering abortion of non-connected state transmission. After the abortion, the terminal device 210 may perform an RRC connection resume procedure. Specifically, the terminal device 210 performs 830-1 the RRC connection resume procedure with the first cell 230-1 by encrypting data with the first sequence number without initialization. In this way, as the first sequence number is not initialized, different sequence numbers will be used during the RRC connection resume procedure even the terminal device 210 continues to communicate with the same cell 230-1.

Alternatively, the terminal device 210 performs the RRC connection resume procedure with a second cell 230-2 by encrypting data with the initialized first sequence number. In this way, as the RRC connection resume procedure is performed in a second cell 230-2 that is different from the first cell 230-1, even if the first sequence number is initialized, the data also can be encrypted uniquely due to different cells.

As one specific example, if the RRC connection resume procedure is performed at the cell that SDT abortion happens, the terminal device 210 discards stored data (such as PDCP PDUs) of the RBs configured for SDT, and continues to use the sequence number (such as, TX_NEXT/COUNT value) for the RBs configured with SDT. Else, if the RRC connection resume procedure is performed at a cell different from the cell that SDT abortion happens, the terminal device 210 discards the stored data (such as PDCP PDUs) of the RBs configured for SDT, and the sequence number (such as, TX_NEXT/COUNT value) for the RBs configured with SDT is initialized.

It can be seen, the above process at least relates to two operations, i.e., discarding the stored data and handing the value of the first sequence number (such as, initializing or do not initializing the first sequence number). Currently the above two operations are implemented in different procedures. Specifically, a common PDCP suspend procedure comprises discarding PDCP PDU and initializing TX_NEXT/COUNT for all DRB. While a common PDCP re-establishment procedure comprises initializing TX_NEXT/COUNT for RLC unacknowledged mode (UM) and SRB. Therefore, none of current procedures may implement the above two operations simultaneously.

According to this present discourse, a further improved is proposed to implement the above two operations.

In some example embodiments, the terminal device 210 (such as, the PDCP entity of the terminal device 210) performs a PDCP suspending procedure the non-connected state transmission abortion. During the PDCP suspending procedure, the terminal device 210 discards stored data (such as, PDCP PDUs) for the RBs configured for non-connected state transmission and receives an indication to disable an initialization of the first sequence number from an RRC layer of the terminal device 210. Further, the terminal device 210 performs a PDCP re-establishing procedure during the RRC connection resume procedure. During the PDCP re-establishing procedure, the terminal device 210 disables initializing the first sequence number if the RRC connection resume procedure is to be performed with the first cell 230-1 and initializes the first sequence number if the RRC connection resume procedure is to be performed with the second cell 230-2. In this way, the above two operations are implemented within different procedures.

Alternatively, the above two operations may be implemented in another manner. Specifically, in some example embodiments, the terminal device 210 performs a PDCP re-establishing procedure during the RRC connection resume procedure. During the PDCP re-establishing procedure, the terminal device 210 discards stored data (such as, PDCP PDUs) for the RBs configured for non-connected state transmission. Further, during the PDCP re-establishing procedure, the terminal device 210 disables initializing the first sequence number if the RRC connection resume procedure is to be performed with the first cell 230-1 and initializes the first sequence number if the RRC connection resume procedure is to be performed with the second cell 230-2.

For better understanding the above processes, two specific example embodiments are provided as below.

In the first specific example embodiment, upon the non-connected state transmission abortion, the terminal device 210 performs the following procedures. Specifically, the terminal device 210 discards the stored data (such as, PDCP PDUs) for the RBs configured with SDT. For example, the terminal device discarding the stored data by performing PDCP suspend procedure, and indicates the sequence number (i.e., TX_NEXT/COUNT value) continuation to the PDCP when perform PDCP suspend for RBs configured with SDT. Further, if the terminal device 210 initiates RRC connection resume procedure at the cell where the terminal device 210 has performed SDT procedure using the current UE inactive AS context before, the terminal device 210 shall continue the sequence number (i.e., TX_NEXT/COUNT value) for the RBs configured with SDT. For example, during the RRC resume procedure, the RRC layer shall indicate the sequence number (i.e., TX_NEXT/COUNT value) continuation to the PDCP when performing PDCP re-establishment for the RBs configured with SDT. Otherwise (i.e., the terminal device 210 initiates RRC connection resume procedure at a cell different from the cell where the terminal device 210 has performed SDT procedure), in the RRC connection resume procedure, the terminal device 210 shall initialize the sequence number (i.e., TX_NEXT/COUNT value) for all RBs configured with SDT including RLC acknowledged mode (AM) DRBs, RLC UM DRBs and SRBs. For example, during the RRC connection resume procedure, the RRC layer shall indicate to initialize the sequence number (i.e., TX_NEXT/COUNT value) for the RLC AM RBs configured with SDT when performing PDCP re-establishment procedure.

In the second specific example embodiment, if the terminal device 210 initiates RRC connection resume procedure at the cell where the terminal device 210 has performed SDT procedure using the current UE inactive AS context before, the terminal device 210 shall discard the PDCP PDUs for the RBs configured with SDT. For example, the terminal device 210 performs PDCP suspend procedure, and indicate sequence number (i.e., TX_NEXT/COUNT value) continuation to the PDCP when perform PDCP suspend procedure for RBs configured with SDT. For another example, the terminal device 210 indicates to discard the stored data (such as, PDCP PDUs) when preforming PDCP re-establishment procedure for the RBs configured with SDT. Further, the continued sequence number (i.e., TX_NEXT/COUNT value) should be used for the RBs configured with SDT. For example, when perform PDCP reestablishment during the RRC connection resume procedure, the RRC layer shall indicate the sequence number (i.e., TX_NEXT/COUNT value) continuation to the PDCP when performing PDCP re-establishment procedure for the RBs configured with SDT. Otherwise (i.e., the terminal device 210 initiates RRC connection resume procedure at a cell different from the cell where the terminal device 210 has performed SDT procedure), the terminal device 210 may discard the stored data (such as, PDCP PDUs) for the RBs configured with SDT, and initializes the sequence number (i.e., TX_NEXT/COUNT value) for all the RBs configured with SDT. For example, the terminal device 210 performs PDCP suspend procedure without indicating the sequence number (i.e., TX_NEXT/COUNT value) continuation, and then performs PDCP re-establishment procedure without indicating sequence number (i.e., TX_NEXT/COUNT value) continuation. For another example, the terminal device 210 performs PDCP re-establishment procedure with indication of PDU discard and initialization of sequence number (i.e., TX_NEXT/COUNT value) for RLC AM DRBs configured with SDT.

In some example embodiments, when upper layers request a PDCP entity suspend, the transmitting PDCP entity shall set TX_NEXT to the initial value, if TX_NEXT continuation is not indicated by the upper layer and discard all stored PDCP PDUs. Additionally, in some example embodiments, when upper layers request a PDCP entity suspend, the receiving PDCP entity shall stop and reset t-Reordering and deliver all stored PDCP SDUs to the upper layers in ascending order of associated COUNT values after performing header decompression if t-Reordering is running, and set RX_NEXT and RX_DELIV to the initial value.

In some example embodiments, when upper layers request a PDCP entity re-establishment, the transmitting PDCP entity shall perform at least one of the following: 1) for UM DRBs and AM DRBs, reset the robust header compression (ROHC) protocol for uplink and start with an initialization and refresh (IR) state in UM if drb-ContinueROHC is not configured; 2) for UM DRBs and AM DRBs, reset the EHC protocol for uplink if drb-ContinueEHC-UL is not configured; 3) for UM DRBs and SRBs, set TX_NEXT to the initial value if TX_NEXT continuation is not indicated ty the upper layer; 4) For AM DRBs, set TX_NEXT to the initial value if TX_NEXT initialization is indicated by the upper layer. for SRBs, discard all stored PDCP SDUs and PDCP PDUs; and 5) For DRBs, discard all stored PDCP PDUs if PDU discard is indicated by the upper layer.

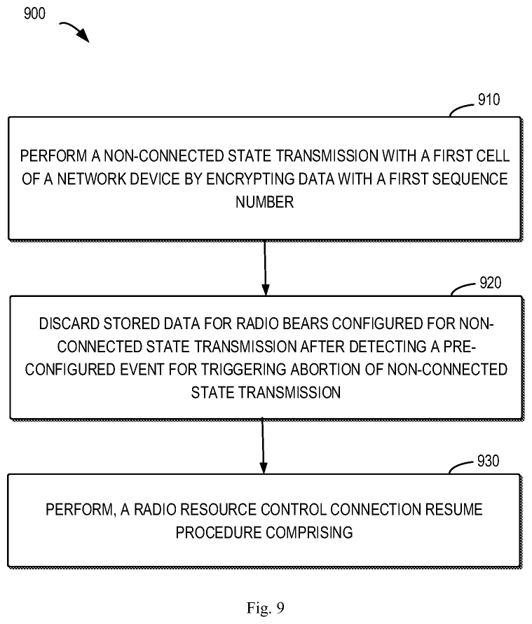

FIG. 9 illustrates a flowchart of an example method 900 in accordance with some embodiments of the present disclosure. For example, the method 900 can be implemented at the terminal device 210 as shown in FIG. 2.

At block 910, the terminal device 210 performs a non-connected state transmission with a first cell 230-1 of a network device 220 by encrypting data with a first sequence number.

At block 920, the terminal device 210 discards stored data for RBs configured for non-connected state transmission after detecting a pre-configured event for triggering abortion of non-connected state transmission

At block 930, the terminal device 210 performs an RRC resume procedure comprising: performing, the RRC connection resume procedure with the first cell 230-1 by encrypting data with the first sequence number without initialization; or performing, the RRC connection resume procedure with a second cell 230-2 of the network device 220 by encrypting data with the initialized first sequence number.

In some example embodiments, in response to detecting the pre-configured event, the terminal device 210 performs, at a PDCP entity, a PDCP suspending procedure, comprising: discarding stored data for the RBs configured for non-connected state transmission; and receiving, from an RRC layer of the terminal device, an indication to disable an initialization of the first sequence number. Further, during the RRC connection resume procedure, the terminal device 210 performs a PDCP re-establishing procedure, comprising: disabling initializing the first sequence number if the RRC connection resume procedure is to be performed with the first cell 230-1; and initializing the first sequence number if the RRC connection resume procedure is to be performed with the second cell 230-2.

In some example embodiments, during the RRC connection resume procedure, the terminal device 210 performs a PDCP re-establishing procedure, comprising: discarding stored PDCP PDUs. During the PDCP re-establishing procedure, the terminal device 210 disables initializing the first sequence number if the RRC connection resume procedure is to be performed with the first cell 230-1 and initializes the first sequence number if the RRC connection resume procedure is to be performed with the second cell 230-2.

In some example embodiments, the terminal device 210 comprises circuitry configured to perform a non-connected state transmission with a first cell 230-1 of a network device 220 by encrypting data with a first sequence number. The circuitry is further configured to discard stored data for RBs configured for non-connected state transmission after detecting a pre-configured event for triggering abortion of non-connected state transmission. The circuitry is also configured to perform an RRC resume procedure comprising: performing, the RRC connection resume procedure with the first cell 230-1 by encrypting data with the first sequence number without initialization; or performing, the RRC connection resume procedure with a second cell 230-2 of the network device 220 by encrypting data with the initialized first sequence number.

In some example embodiments, in response to detecting the pre-configured event, the circuitry is further configured to perform, at a PDCP entity, a PDCP suspending procedure, comprising: discarding stored data for the RBs configured for non-connected state transmission; and receiving, from an RRC layer of the terminal device 210, an indication to disable an initialization of the first sequence number. Further, during the RRC connection resume procedure, the circuitry id further configured to perform a PDCP re-establishing procedure, comprising: disabling initializing the first sequence number if the RRC connection resume procedure is to be performed with the first cell 230-1; and initializing the first sequence number if the RRC connection resume procedure is to be performed with the second cell 230-2.

In some example embodiments, during the RRC connection resume procedure, the circuitry is further configured to perform a PDCP re-establishing procedure, comprising: discarding stored PDCP PDUs. During the PDCP re-establishing procedure, the circuitry is further configured to disable initializing the first sequence number if the RRC connection resume procedure is to be performed with the first cell 230-1 and initialize the first sequence number if the RRC connection resume procedure is to be performed with the second cell 230-2.

### Example Embodiments for Transitioning Into an Idle State

In addition to the above example processes, the terminal device 210 may transition into an idle state upon some pre-configured events during performing of a non-connected state transmission.

In accordance with some example embodiments of the present disclosure, there is provided a solution for communication. In this solution, the terminal device 210 detects at least one pre-configured event during performing of a non-connected state transmission by the terminal device 210 with a network device 220. Then, the terminal device 210 transitions into an idle state.

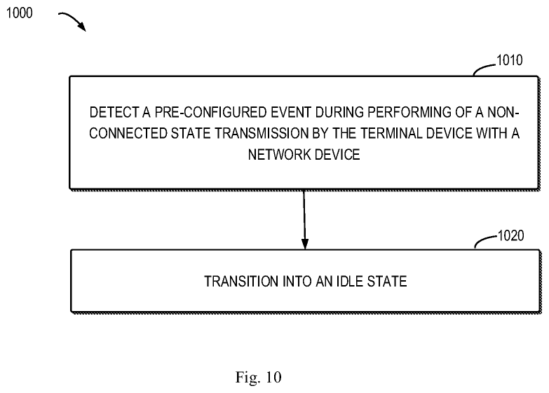

Reference is made to FIG. 10, which illustrates example method 1000 performed by the terminal device 210 for avoiding key stream reusing.

At block 1010, the terminal device 210 detects a pre-configured event during performing of a non-connected state transmission by the terminal device 210 with a network device 220. At block 1020, the terminal device 210 transitions into an idle state.

One example of the non-connected state transmission is SDT. Another example of the non-connected state transmission is EDT. A further example of the non-connected state transmission is PUR.

In some example embodiments, the terminal device 210 receives an RRC reject message from the network device 220, and then determines the pre-configured event occurs. Alternatively, the terminal device 210 detects a failure of meeting a quality requirement of performing non-connected state transmission, and then determines the pre-configured event Occurs.

In some example embodiments, as for SDT, the pre-configured events, include but not are limited to, cell re-selection; expiry of failure detection timer of SDT; maximum number of retransmissions is reached in RLC; receiving RRC reject message during SDT; abortion of connection resuming procedure by upper layers; receiving RAN paging during SDT; arriving of non-SDT data/signaling at the terminal device 210 side; RSRP requirement is not fulfilled during SDT; lower layer (such as, MAC layer) indicates the abortion of SDT, e.g. due to no suitable resource.

In some example embodiments, as for any of EDT and PUR, the pre-configured events, include but not are limited to, expiry of T300, receipt of RRC connection rejection and cell re-selection.

In some example embodiments, as for any of EDT and PUR, if the terminal device 210 detects the pre-configured events, the terminal device 210 discards the security context (such as, nextHopChainingCount) and indicates the release of the RRC connection to upper layers.

In some example embodiments, upon detecting the pre-configured events, especially upon receiving RRCReject/RSRP requirement is not fulfilled during SDT, the terminal device 210 performs the procedure of going to RRC IDLE with release cause “RRC Resume failure”. In this way, the NAS layer will perform NAS recovery.

In some example embodiments, the terminal device 210 comprises circuitry configured to detect a pre-configured event during performing of a non-connected state transmission by the terminal device 210 with a network device 220. The circuitry is further configured to transition into an idle state.

In some example embodiments, the circuitry is further configured to receive from the network device 220 an RRC reject message or detect a failure of meeting a quality requirement of performing non-connected state transmission.

### Example Processes for Cell Re-Selection

Currently, the terminal device may perform measurement on different cells and perform cell re-selection based on the measurement results. Currently, if there is any cell on frequency with higher priority is detected, and the radio condition of the cell is above a certain level, the terminal device will re-select to the cell. If the terminal device transitions into an idle state due to cell re-selection during SDT, it will result in data loss. However, if the terminal device remains in inactive state upon cell re-selection, there would be security issues. Therefore, it is expected that the terminal device can finish the SDT procedure in the current cell as much as possible.

In accordance with some example embodiments of the present disclosure, there is provided a solution for communication. In this solution, the terminal device 210 decreases a possibility of switching to a second cell 230-2 configured with a second frequency different from a first frequency when the terminal device 210 performing a SDT with a first cell configured with the first frequency. In this way, the terminal device 210 will not re-select to a neighboring cell with higher priority during SDT procedure, unless the channel condition is very bad.

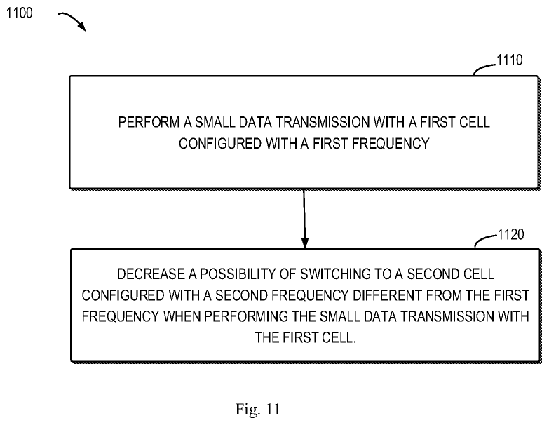

FIG. 11 illustrates a flowchart of an example method 1100 in accordance with some embodiments of the present disclosure. For example, the method 1100 can be implemented at the terminal device 210 as shown in FIG. 2. For the purpose of discussion, the method 1100 will be described with reference to FIG. 2. The method 1100 may involve the terminal device 210, cell 230-1 and cell 230-2. In the following text, the cell 230-1 also is referred to the first cell 230-1, while the cell 230-2 also is referred to the second cell 230-2.

At block 1110, the terminal device 210 performs an SDT with a first cell 230-1 configured with a first frequency.

At block 1120, the terminal device 210 decreases a possibility of switching to a second cell configured with a second frequency different from the first frequency when performing the small data transmission with the first cell.

In some example embodiments, the terminal device 210 considers the current frequency as the highest priority for cell re-selection. Specifically, the terminal device 210 decreasing the possibility of switching to a second cell by increasing a priority of the first frequency when performing a cell re-selection procedure.

Alternatively, in some example embodiments, the terminal device 210 does not perform inter-frequency measurement during SDT. Specifically, the terminal device 210 decreasing the possibility of switching to a second cell by disabling inter-frequency measurement when performing a cell re-selection procedure.

In some example embodiments, the terminal device 210 comprises circuitry configured to perform an SDT with a first cell 230-1 configured with a first frequency. The circuitry is further configured to decrease a possibility of switching to a second cell configured with a second frequency different from the first frequency when performing the small data transmission with the first cell.

In some example embodiments, the circuitry is further configured to decrease the possibility of switching to a different second cell by increasing the priority of the first frequency when performing a cell re-selection procedure.

In some example embodiments, the circuitry is further configured to decrease the possibility of switching to a different second cell by disabling inter-frequency measurement when performing a cell re-selection procedure.

### Example Processes for Handing PDCP Configuration

Currently, SRB1 is used for receiving RRC message. Generally speaking, the RRC message bearers important control information. Therefore, during the RRC connection resume procedure (for example, when transmitting RRC resume request message), the terminal device applies the default configuration for SRB1 without restoring the PDCP configuration for SRB1, such that the terminal device may receive RRC message. Further, it is agreed that in addition the DRBs, both SRB1 and SRB2 can be used for SDT. Therefore, the handling of the PDCP configuration for SRB1 needs further discussion.

### Example Embodiments for Restoring PDCP Configuration

In accordance with some example embodiments of the present disclosure, there is provided a solution for communication. In this solution, the terminal device 210 applies the default configuration for the RB(s) configured for bearing RRC message (such as, SRB1). Alternatively, the terminal device 210 restores PDCP configuration for the RB(s) configured for bearing RRC message (such as, SRB1).

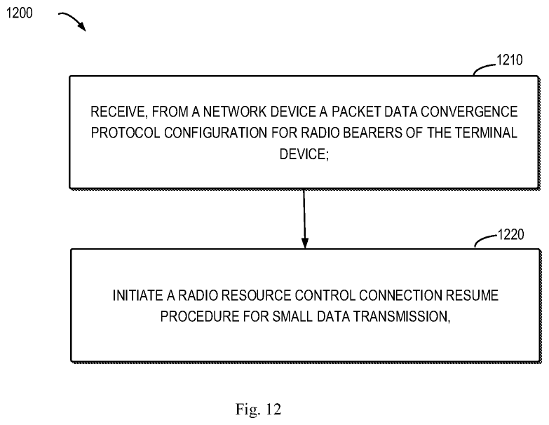

FIG. 12 illustrates a flowchart of an example method 1200 in accordance with some embodiments of the present disclosure. For example, the method 1200 can be implemented at the terminal device 210 as shown in FIG. 2.

At block 1210, the terminal device 210 receives a PDCP configuration for RBs of the terminal device 210.

At block 1220, the terminal device 210 initiates an RRC connection resume procedure for SDP.

In some embodiments, the terminal device 210 applies default configuration for the RB configured for bearing RRC message (such as, SRB1) even if it is configured SDT. For example, the terminal device 210 initiates an RRC connection resume procedure for SDP comprising: applying a default PDCP configuration for the RB configured for bearing RRC message without restoring the PDCP configuration to the radio bearer; and restoring the PDCP configuration for RBs configured for SDT except the RB configured for bearing RRC message.

In addition, in some embodiments, the terminal device 210 restores the PDCP configuration from a stored UE Inactive AS context for RBs configured with SDT except for SRB1.

In addition, in some embodiments, in response to receiving an RRC resume message, the terminal device 210 restores the PDCP configuration for RBs not configured for SDT, and the RB configured for bearing RRC message.

As one specific example, if the terminal device 210 receives an RRC resume message during SDT, and the RRC resume message doesn't includes the fullConfig, the terminal device 210 restore PDCP configuration for the RBs not configured with SDT and the RB configured for bearing RRC message (such as, SRB1) from the UE Inactive AS context.

Alternatively, in some embodiments, the terminal device 210 restores PDCP for all RBs configured with SDT. Specifically, the terminal device 210 initiates an RRC connection resume procedure for SDP comprising: restoring the PDCP configuration for RBs configured for SDT including the RB configured for bearing RRC message (such as, SRB1).

In some embodiments, the terminal device 210 restores the PDCP configuration from a stored UE Inactive AS context for all RBs (including SRB1) configured with SDT

In addition, in some embodiments, the terminal device 210 transitions into an idle state in response to detecting a failure of receipt of an RRC resume message. As one specific example, if the terminal device 210 is unable to comply the RRC resume message, the terminal device 210 performs the actions of transitioning into idle state with release cause RRC resume failure.

In addition, in some embodiments, the terminal device 210 restores the PDCP configuration for RBs not configured for SDT in response to receiving an RRC resume message.

As one specific example, if the terminal device 210 receives an RRC resume message during SDT, and the RRC resume message doesn't includes the fullConfig, the terminal device 210 restore PDCP configuration for the RBs not configured with SDT from the UE Inactive AS context.

In some example embodiments, the terminal device 210 comprises circuitry configured to receive, from a network device 220 a PDCP configuration for RBs of the terminal device 210. The circuitry is further configured to initiate an RRC connection resume procedure for SDT, comprising: applying a default PDCP configuration for the RB configured for bearing RRC message without restoring the PDCP configuration to the RS and restore the PDCP configuration for RBs configured for SDT except the RB configured for bearing RRC message.

In some example embodiments, the circuitry is further configured to in response to receiving an RRC resume message, restore the PDCP configuration for: RBs not configured for SDT, and the RB configured for bearing RRC message.

In some example embodiments, the RB configured for bearing RRC message is SRB1.

In some example embodiments, the terminal device 210 comprises circuitry configured to receive, from a network device 220 a PDCP configuration for RBs of the terminal device 210. The circuitry is further configured to initiate an RRC connection resume procedure for SDT, comprising: restoring the PDCP configuration for RBs configured for SDT including the RB configured for bearing RRC message.

In some example embodiments, the circuitry is further configured to transition into an idle state in response to detecting a failure of receipt of an RRC resume message.

In some example embodiments, the circuitry is further configured to restores the PDCP configuration for RBs not configured for SDT in response to receiving an RRC resume message.

In some example embodiments, the RB configured for bearing RRC message is SRB1.

### Example Embodiments for Configuring PDCP Configuration at the Network Device

In accordance with some example embodiments of the present disclosure, there is provided a solution for communication. In this solution, if the network device 220 configures the RB configured for bearing RRC message (such as, SRB1) for SDT, the network device 220 shall configure the PDCP configuration of SRB1 with the same PDCP configuration as the default SRB1 configuration.

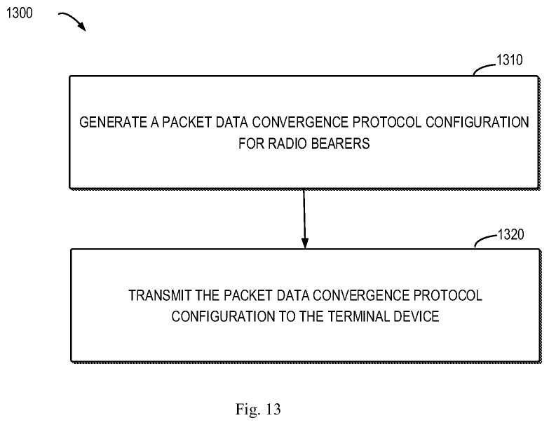

FIG. 13 illustrates a flowchart of an example method 1300 in accordance with some embodiments of the present disclosure. For example, the method 1300 can be implemented at the network device 220 as shown in FIG. 2.

At block 1310, the network device 220 generates a PDCP configuration for RBs, the RBs including a RB configured for bearing RRC message, the RB being configured with a default PDCP configuration if the RB is configured for SDT.

At bock 1320, the network device 220 transmits the PDCP configuration to the terminal device 210.

In some example embodiments, the RB configured for bearing RRC message is SRB1.

In some example embodiments, the network device 220 comprises circuitry configured to generate a PDCP configuration for RBs, the RBs including a RB configured for bearing RRC message, the RB being configured with a default PDCP configuration if the RB is configured for SDT. The circuitry is further configured to transmit the PDCP configuration to the terminal device 210.

In some example embodiments, the RB configured for bearing RRC message is SRB1.

### Example Devices

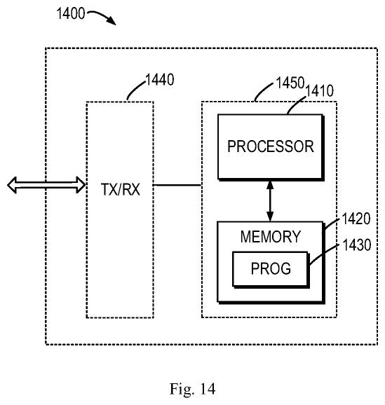

FIG. 14 is a simplified block diagram of a device 1400 that is suitable for implementing embodiments of the present disclosure. The device 1400 can be considered as a further example implementation of the terminal device 210 and the network device 220 as shown in FIG. 2. Accordingly, the device 1400 can be implemented at or as at least a part of the terminal device 210, the network device 220.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1430 is assumed to include program instructions that, when executed by the associated processor 1410, enable the device 1400 to operate in accordance with the embodiments of the present disclosure, as discussed herein with reference to FIGS. 2-13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1410 may form processing means 1450 adapted to implement various embodiments of the present disclosure.

The memory 1410 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1410 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 and 4-18. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-44. (canceled)

45. A method performed by a terminal device, comprising:
receiving a radio resource control (RRC) reject message; and
discarding stored packet data convergence protocol (PDCP) protocol data units (PDUs) for radio bearers configured for small data transmission (SDT).

46. The method of claim 45, further comprising:
transmitting a RRC resume request message,
wherein the transmitting comprises:
determining a resume procedure is initiated for SDT; and
restoring PDCP configuration from a user equipment (UE) inactive access stratum (AS) context for the radio bearers configured for SDT and for signalling radio bearer 1 (SRB1).

47. A terminal device comprising a processor configured to cause the terminal device to:
receive a radio resource control (RRC) reject message; and
discard stored packet data convergence protocol (PDCP) protocol data units (PDUs) for radio bearers configured for small data transmission (SDT).

48. The terminal device of claim 47, wherein the processor is further configured to cause the terminal device to:
transmit a RRC resume request message,
wherein the processor is configured to cause the terminal device to transmit the RRC resume request message by:
determining a resume procedure is initiated for SDT; and
restoring PDCP configuration from a user equipment (UE) inactive access stratum (AS) context for the radio bearers configured for SDT and for signalling radio bearer 1 (SRB1).
